(19) United States
(12) Patent Application Publication
(10) Pub. No.: US 2026/0021011 A1
(43) Pub. Date: Jan. 22, 2026

(54) MANUAL PRESSURE MASSAGE DEVICE

(71) Applicant: Xiaoke Zhou, Mount Huangshan (CN)

(72) Inventor: Xiaoke Zhou, Mount Huangshan (CN)

(21) Appl. No.: 19/343,563

(22) Filed: Sep. 29, 2025

(51) Int. Cl. A61H 9/00

(52) U.S. Cl. CPC A61H 9/0057; A61H 2201/1253; A61H 2201/1409; A61H 2201/168; A61H 2201/5056

(57) ABSTRACT

A manual pressure massage device, which comprises an adjustable airbag and a rigid airbag, wherein a connecting part is arranged between the rigid airbag and the adjustable airbag, a second check valve mechanism for connecting the adjustable airbag and the rigid airbag is arranged on the connecting part, the adjustable airbag is provided with a first check valve mechanism for connecting to the outside, the second check valve mechanism is opposite to the first check valve mechanism, and the rigid airbag is provided with a massage opening, which is in turn provided with a circular extension part extending to the side. The user only needs to manually and repeatedly squeeze the adjustable airbag to efficiently generate negative pressure at the massage opening of the rigid airbag. The proposal eliminates the need for expensive and complex components such as circuits, motors, or batteries, resulting in an extremely simple structure.

### TECHNICAL FIELD

The utility model relates to the technical field of transmission mechanisms, particularly to a manual pressure massage device.

### BACKGROUND ART

With increasing health consciousness in recent years, various massage devices have gained popularity due to their effectiveness in relieving fatigue and relaxing muscles. Among them, devices utilizing the principle of negative pressure to provide massage apply periodic pressure changes to specific sites of the human body, promoting blood circulation and achieving a soothing effect. However, existing devices with negative pressure massage functions generally suffer from the following significant drawbacks:

1. Complex design and high cost: Common negative pressure massage devices often rely on electric drives (such as electric pumps or electromagnetic devices) to generate negative pressure. Such devices require complex circuit control systems, driving components and power sources, resulting not only in bulky dimensions and significant manufacturing costs, but also in issues with power consumption and limited usage scenarios (e.g., requiring power outlets or frequent battery replacement).

2. Uncontrollable negative pressure and safety risks: Some traditional or simplified negative pressure generation methods, such as those based on principles similar to cupping therapy (applying alcohol to a cup-shaped container, igniting it, and quickly placing it on the surface of the skin after partial oxygen consumption to create negative pressure through cooling) are employed. It is difficult to precisely control the negative pressure intensity in this way. Excessive negative pressure can easily lead to subcutaneous capillary rupture (bruising) or soft tissue damage, and improper operation may even cause burns or fire hazards. Both the safety and user experience provided by such methods are notably poor.

3. Inconvenient operation or ineffective results: The two main methods mentioned above are either cumbersome to operate (requiring power connection and setup) or involve high risks (open flames). Moreover, they struggle to achieve precise and flexible adjustment of the negative pressure intensity based on individual needs or different body parts.

### SUMMARY OF THE UTILITY MODEL

The utility model aims to provide a manual pressure massage device, featuring a simple structural design, convenient operation, good safety, reliability, and effective control of the negative pressure intensity.

To solve the above problems, the utility model provides a manual pressure massage device, which comprises an adjustable airbag and a rigid airbag, wherein a connecting part is arranged between the rigid airbag and the adjustable airbag, a second check valve mechanism for connecting the adjustable airbag and the rigid airbag is arranged on the connecting part, the adjustable airbag is provided with a first check valve mechanism for connecting to the outside, the second check valve mechanism is opposite to the first check valve mechanism, and the rigid airbag is provided with a massage opening, which is provided with a circular extension part extending to the side.

As the technical proposal of one preferred embodiment, the first check valve mechanism comprises a first air valve body and a first flexible rubber air valve core, the first air valve body is provided with a first air hole structure and a first baffle block located at the first air hole structure, the first air hole structure comprises a first through hole arranged at the first baffle block as well as a first air outlet cavity and a first air inlet cavity located at both ends of the first through hole, the first flexible rubber air valve core comprises a first valve core cover and a first column connected to the first valve core cover, a first annular limit part is arranged on the first column, a first limit slot is formed between the first limit part and the first valve core cover, the first valve core cover is located at the end of the first air hole away from the rigid airbag, the first column runs through the through hole, and the first limit slot comes into contact with the wall of the first through hole.

As the technical proposal of one preferred embodiment, a first annular fixing strip is arranged on the outer side of the first air valve body and fixed with an annular fixing groove on the adjustable airbag.

As the technical proposal of one preferred embodiment, the first column is located away from the center of the first valve core cover.

As the technical proposal of one preferred embodiment, the upper surface of the first valve core cover is convex.

As the technical proposal of one preferred embodiment, the side of the first limit part away from the first valve core cover is an inclined plane.

As the technical proposal of one preferred embodiment, the second check valve mechanism comprises a second air valve body and a second flexible rubber air valve core, the second air valve body is provided with a second air hole structure and a second baffle block located at the second air hole structure, the second air hole structure comprises a second through hole arranged at the second baffle block as well as a second air outlet cavity and a second air inlet cavity located at both ends of the second through hole, the second flexible rubber air valve core comprises a second valve core cover and a second column connected to the second valve core cover, a second annular limit part is arranged on the second column, a second limit slot is formed between the second limit part and the second valve core cover, the second valve core cover is located at the end of the second air hole away from the rigid airbag, the second column runs through the through hole, and the second limit slot comes into contact with the wall of the second through hole.

As the technical proposal of one preferred embodiment, second annular fixing strips are arranged on the outer side of the second air valve body and fixed with an annular fixing groove on the connecting part, the first column is located away from the center of the second valve core cover, and the upper surface of the second valve core cover is convex.

### Beneficial Effects

1. The adjustable airbag, the rigid airbag as well as the first check valve mechanism (connected to the outside) and the second check valve mechanism (connected to both airbags) arranged in opposite directions on the connecting part completely eliminate the traditional reliance on electric drives or complex mechanical structures for generating negative pressure. The user only needs to manually and repeatedly squeeze the adjustable airbag to efficiently generate negative pressure at the massage opening of the rigid airbag. The proposal eliminates the need for expensive and complex components such as circuits, motors, or batteries, resulting in an extremely simple structure that significantly reduces manufacturing costs and failure rates while expanding the range of usage scenarios (no power supply is required).

2. This proposal completely removes the risks associated with open-flame operations, burns and fire hazards present in traditional methods such as alcohol combustion described in the background art. The entire negative pressure generation process is achieved purely through physical structures (airbag deformation, check valve opening/closing), with no heat sources or chemical reactions involved, fundamentally ensuring user safety.

3. Users can flexibly and linearly adjust the negative pressure intensity applied to the massage site by controlling the frequency and force of manually squeezing the adjustable airbag. The more frequently the airbag is squeezed, the greater the negative pressure formed within the rigid airbag and the stronger the suction force is. This addresses the core drawbacks of inconvenient adjustment in electric devices and the uncontrollable nature of pressure in combustion-based methods mentioned in the background art.

### BRIEF DESCRIPTION OF THE DRAWINGS

To provide a clearer description of the embodiments in the utility model or the technical proposals in the prior art, the drawings required for describing the embodiments or the prior art will be briefly introduced below. Obviously, the drawings in the description merely show some embodiments of the utility model and therefore should not be considered as limiting the scope. Those skilled in the art can obtain other related drawings based on these drawings without creative effort.

FIG. 1 is a sectional structural diagram of the manual pressure massage device along the center in an embodiment of the utility model.

FIG. 2 is an enlarged view of the partial structure in FIG. 1.

FIG. 3 is a structural diagram of the first check valve mechanism.

FIG. 4 is a partial structural diagram of the flexible rubber air valve core.

FIG. 5 is a sectional structural diagram of the flexible rubber air valve core along the lengthwise direction.

FIG. 6 is a sectional structural diagram of the fixing column.

The realization of the objectives, functional features, and advantages of the utility model will be further explained in conjunction with the embodiments and with reference to the drawings.

### DETAILED DESCRIPTION OF THE UTILITY MODEL

The claims of the utility model are further described in detail with reference to the embodiments and drawings. Obviously, the described embodiments are only a part of the embodiments of the utility model, but not all of them. Based on the embodiments of the utility model, all other embodiments obtained by those of ordinary skill in the art without creative efforts shall fall within the scope of protection of the utility model.

It should be understood that all directional terms such as “upper”, “lower”, “left”, “right”, “front” and “rear” indicating orientation or positional relationships in the embodiments of the utility model are based on the orientation or positional relationships shown in the drawings, or the usual orientation or positional relationships when the product of the utility model is in use. These terms are used solely to simplify the description of the utility model and do not explicitly or implicitly indicate that the referred devices, elements, or components must have specific orientations or be constructed in specific orientations. They should not be construed as limiting the utility model. They are only used to explain the relative positional relationships, movements, etc., between components as depicted in the drawings. When the specific positioning of the device changes, the directional indications may also change accordingly.

Furthermore, ordinal numerals such as “first” and “second” in the utility model are only used for distinguishing purposes and should not be understood as indicating or suggesting their relative importance or implicitly indicating the quantity of technical features indicated. Thus, the features defining “first” and “second” may explicitly or implicitly include at least one such technical feature. In the description of the utility model, “a plurality of” means at least two, that is, two or more, unless otherwise expressly defined; “at least one” means one or more.

In the utility model, unless otherwise explicitly specified and defined, terms such as “install”, “arrange”, “connect”, “fix” and “screw” should be understood in a broad sense. For example, they may refer to relatively fixed positional relationships between components, physically fixed connections between components, detachable connections, or integrated structures; they may indicate mechanical connections, electrical signal connections, direct connections, or indirect connections through intermediate media or components; they may describe internal communication between two elements or interactive relationships between two elements. Unless the specification explicitly states otherwise, those skilled in the art may understand the specific meanings of these terms in the context of the utility model based on specific circumstances, except where other interpretations would prevent the realization of corresponding functions or effects.

The controllers and control circuits involved in the utility model, if any, belong to conventional control technologies or devices familiar to those skilled in the art. For example, the control circuits of the controllers can be implemented by ordinary technicians using existing methods, such as simple programming. Software or programs used with hardware to achieve a control effect, if not described in detail in the specification, belong to the prior art or conventional techniques known to ordinary technicians in the field. Power supplies also belong to the prior art. Since the primary technical point of the utility model lies in the improvement of mechanical devices, specific circuit control relationships and connections are not elaborated in detail.

The disclosure of the utility model provides various embodiments or examples for implementing different structures of the utility model. To simplify the disclosure, the components and configurations of specific examples are described herein. Of course, these are merely illustrative and are not intended to limit the utility model. Furthermore, the utility model may repeat reference numerals and/or reference letters across different examples. Such repetition is for the purposes of simplification and clarity and does not inherently indicate relationships between the various embodiments and/or arrangements discussed. Additionally, the utility model provides examples of specific processes and materials, but those of ordinary skill in the art may recognize the applicability of other processes and/or the use of other materials.

The preferred embodiments of the utility model are described below with reference to the drawings. It should be understood that the preferred embodiments described herein are intended only to describe and explain the utility model and not to limit it.

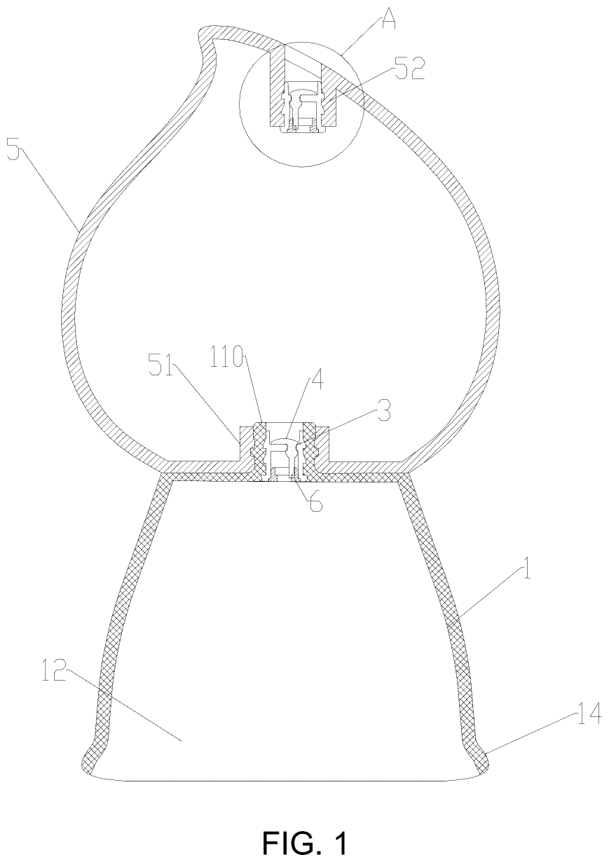

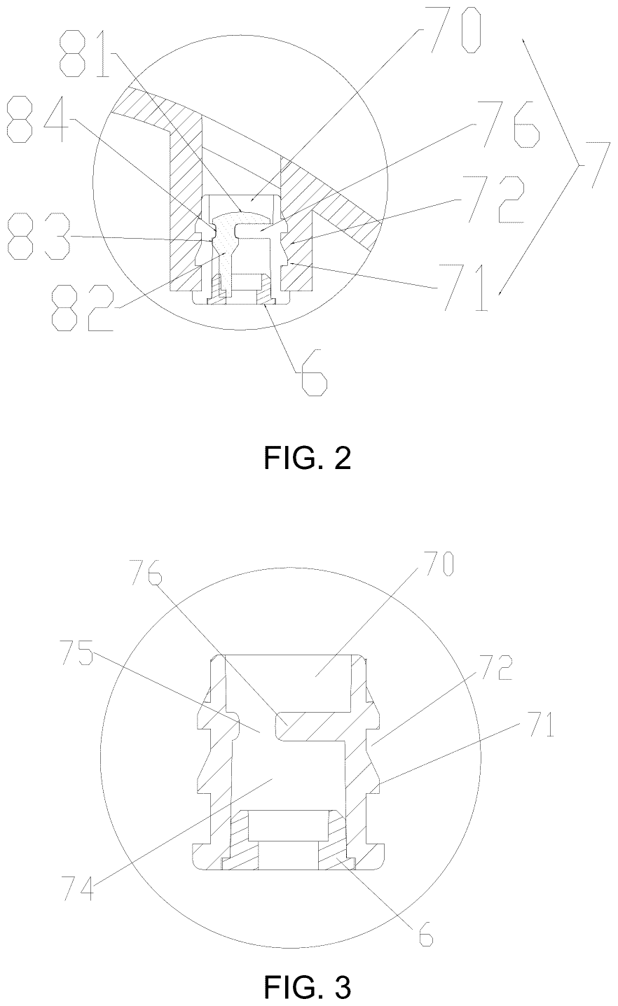

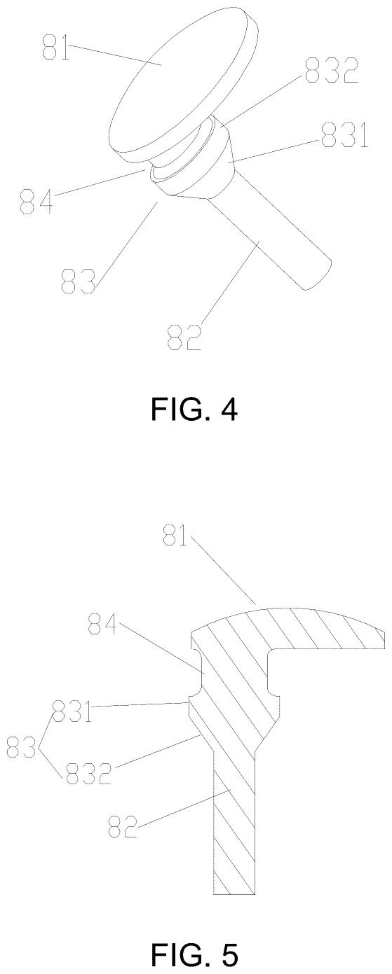

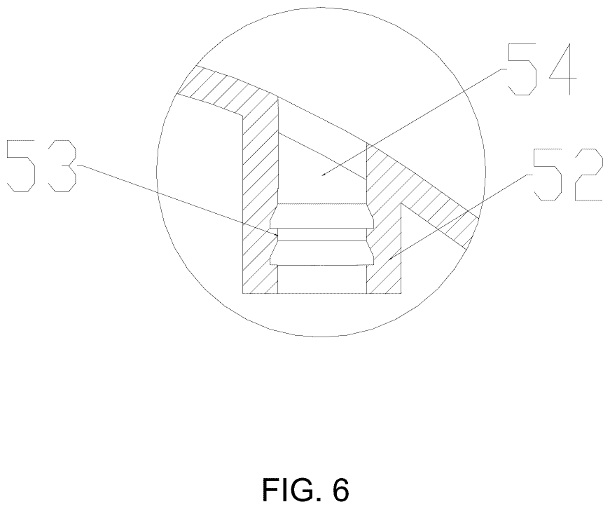

As shown in FIGS. 1-6, the utility model provides an embodiment of a manual pressure massage device.

The manual pressure massage device comprises an adjustable airbag 5 and a rigid airbag 1, wherein a connecting part is arranged between the rigid airbag 1 and the adjustable airbag 5, a second check valve mechanism for connecting the adjustable airbag 5 and the rigid airbag 1 is arranged on the connecting part, the adjustable airbag 5 is provided with a first check valve mechanism for connecting to the outside, the second check valve mechanism is opposite to the first check valve mechanism, and the rigid airbag 1 is provided with a massage opening 12, which is provided with a circular extension part 14 extending to the side.

Specifically, the statement that the second check valve mechanism is opposite to the first check valve mechanism means that one check valve mechanism is open while another check valve mechanism is closed during operation. The first check valve mechanism comprises a first air valve body 7 and a first flexible rubber air valve core 8. The first air valve body 7 is provided with a first air hole structure and a first baffle block 76 located at the first air hole structure. The first air hole structure comprises a first through hole 75 arranged at the first baffle block 76 as well as a first air outlet cavity 70 and a first air inlet cavity 74 located at both ends of the first through hole 75. The first flexible rubber air valve core 80 comprises a first valve core cover 81 and a first column 82 connected to the first valve core cover 80. A first annular limit part 83 is arranged on the first column 82. A first limit slot 84 is formed between the first limit part 83 and the first valve core cover 81. The first valve core cover 81 is located at the end of the first air hole away from the rigid airbag 1. The first column 82 runs through the through hole 75. The first limit slot 84 comes into contact with the wall of the first through hole. The first limit slot 84 is preferably annular, to enhance the air sealing performance. A first annular fixing strip 71 is arranged on the outer side of the first air valve body 7, and a clamping slot 72 is formed between the two first annual fixing strips 71. The first column 82 is located away from the center of the first valve core cover 81. The upper surface of the first valve core cover 81 can be convex. The first annular limit part 83 comprises a clamping part 831 and an inclined installation surface 832. The inclined installation surface 832 is located on the side away from the first valve core cover 81, and the clamping part 831 is located on the side of the first clamping slot 72. For convenience of installation, the first through hole 75 can be clamped in the first limit slot 84 formed by the first annular limit part 83. In this embodiment, an air valve bonnet 6 is arranged at the end of the first air valve body 7.

A fixing column 52 is arranged in the cavity of the adjustable airbag 5, a fixing hole 54 is provided on the fixing column 52, and fixing teeth 53 are arranged on the wall of the fixing hole 54.

The second check valve mechanism is the same as the first check valve mechanism. In other words, the second check valve mechanism comprises a second air valve body 3 and a second flexible rubber air valve core 4. The second air valve body 3 is provided with a second air hole structure and a second baffle block located at the second air hole structure (not indicated in the drawing). The second air hole structure comprises a second through hole arranged at the second baffle block as well as a second air outlet cavity and a second air inlet cavity located at both ends of the second through hole. The second flexible rubber valve core comprises a second valve core cover and a second column connected to the second valve core cover. A second annular limit part is arranged on the second column. A second limit slot is formed between the second limit part and the second valve core cover. The second valve core cover is located at the end of the second air hole away from the rigid airbag. The second column runs through the through hole. The second limit slot comes into contact with the wall of the second through hole. second annular fixing strips are arranged on the outer side of the second air valve body, on the outer side of the second air valve body. A second clamping slot is formed between the two second annular fixing strips. The second check valve mechanism is arranged in the mounting hole (not indicated in the drawing) on the connecting part. When the second flexible rubber valve core 4 is matched with the mounting hole, a seal cavity is formed between the second clamping slot and the wall of the mounting hole, preventing air leakage during inflation and deflation and avoiding the risk of failing to reach the pressure required for massage.

In this embodiment, the connecting part 19 comprises a connecting column 110 integrated with the rigid airbag 1 and a connecting sleeve 51 integrated with the adjustable airbag 5. The mounting hole is provided on the connecting column 110, and the connecting sleeve 51 is fixed on the surface of the connecting column 110. A third limiting structure is arranged between the two, and can be a limiting ring or a limiting groove, etc. to prevent the two from loosening.

During deflation, the second check valve mechanism closes under pressure by manually squeezing the adjustable airbag 5, while the rigid airbag 1 maintains an airtight seal. At this point, as the adjustable airbag 5 compresses and internal pressure increases, the first check valve mechanism opens, releasing air from the adjustable airbag 5. When released, the adjustable airbag 5 generates negative pressure under its own resilience force. At this time, the first check valve mechanism closes due to negative pressure, while the second check valve mechanism opens due to negative pressure. Air in the rigid airbag 1 is discharged into the adjustable airbag 5, reducing pressure inside the rigid airbag 1 to create negative pressure and suction. By repeatedly squeezing the adjustable airbag 5, the negative pressure in the rigid airbag 1 increases. When the massage opening 12 acts on the massage site, the massage site within the opening protrudes under the negative pressure, and suction intensifies. This process can be performed repeatedly or once to achieve continuous or single massage.

During inflation, by changing the directions of both the first and second check valve mechanisms simultaneously and manually squeezing the adjustable airbag 5, the first check valve mechanism closes under pressure, sealing the adjustable airbag 5. Simultaneously, the second check valve mechanism opens due to air pressure, allowing air to be discharged into the rigid airbag 1. When the adjustable airbag 5 is released, the second check valve mechanism maintains the rigid airbag 1 in a sealed state. The pressure within the rigid airbag 1 increases by repeatedly squeezing the adjustable airbag 5. When the massage opening 12 acts on the massage site, the massage site within the opening is compressed, and the pressure at the massage opening 12 intensifies. This process can be performed repeatedly or once to achieve continuous or single massage.

Due to the special structure at the massage opening, any local discomfort caused by limited contact area with the massage site during deflation and pressure-relief massage is prevented, thereby reducing marks left at the massage site.

The above embodiments are merely intended to illustrate the technical proposals of the utility model rather than to limit them. Although the utility model has been described in detail with reference to the foregoing embodiments, those of ordinary skill in the art should understand that they may still modify the technical proposals described in the foregoing embodiments or make equivalent replacements to some of the technical features. Such modifications or replacements do not cause the essence of the corresponding technical proposals to depart from the spirit and scope of the technical proposals of the embodiments in the utility model.

1. A manual pressure massage device, comprising an adjustable airbag and a rigid airbag, wherein a connecting part is arranged between the rigid airbag and the adjustable airbag, a second check valve mechanism for connecting the adjustable airbag and the rigid airbag is arranged on the connecting part, the adjustable airbag is provided with a first check valve mechanism for connecting to the outside, the second check valve mechanism is opposite to the first check valve mechanism, and the rigid airbag is provided with a massage opening, which is in turn provided with a circular extension part extending to the side.

2. The manual pressure massage device according to claim 1, wherein the first check valve mechanism comprises a first air valve body and a first flexible rubber air valve core, the first air valve body is provided with a first air hole structure and a first baffle block located at the first air hole structure, the first air hole structure comprises a first through hole arranged at the first baffle block as well as a first air outlet cavity and a first air inlet cavity located at both ends of the first through hole, the first flexible rubber air valve core comprises a first valve core cover and a first column connected to the first valve core cover, a first annular limit part is arranged on the first column, a first limit slot is formed between the first limit part and the first valve core cover, the first valve core cover is located at the end of the first air hole away from the rigid airbag, the first column runs through the through hole, and the first limit slot comes into contact with the wall of the first through hole.

3. The manual pressure massage device according to claim 2, wherein a first annular fixing strip is arranged on the outer side of the first air valve body and fixed with an annular fixing groove on the adjustable airbag, and the first column is located away from the center of the first valve core cover.

4. The manual pressure massage device according to claim 3, wherein the upper surface of the first valve core cover is convex.

5. The manual pressure massage device according to claim 2, wherein the side of the first limit part away from the first valve core cover is an inclined plane.

6. The manual pressure massage device according to claim 1, wherein the second check valve mechanism comprises a second air valve body and a second flexible rubber air valve core, the second air valve body is provided with a second air hole structure and a second baffle block located at the second air hole structure, the second air hole structure comprises a second through hole arranged at the second baffle block as well as a second air outlet cavity and a second air inlet cavity located at both ends of the second through hole, the second flexible rubber air valve core comprises a second valve core cover and a second column connected to the second valve core cover, a second annular limit part is arranged on the second column, a second limit slot is formed between the second limit part and the second valve core cover, the second valve core cover is located at the end of the second air hole away from the rigid airbag, the second column runs through the through hole, and the second limit slot comes into contact with the wall of the second through hole.

7. The manual pressure massage device according to claim 6, wherein second annular fixing strips are arranged on the outer side of the second air valve body are arranged on the outer side of the second air valve body and fixed with an annular fixing groove on the connecting part, the first column is located away from the center of the second valve core cover, and the upper surface of the second valve core cover is convex.
